(19) United States
(12) Patent Application Publication
(10) Pub. No.: US 2022/0101314 A1
(43) Pub. Date: Mar. 31, 2022

(54) COIN-MIXING SERVICE ANALYSIS METHOD BASED ON HEURISTIC TRANSACTION ANALYSIS

(71) Applicant: ZHEJIANG UNIVERSITY, Hangzhou City (CN)

(72) Inventors: Yajin ZHOU, Hangzhou City (CN); Yufeng HU, Hangzhou City (CN); Lei WU, Hangzhou City (CN); Kui REN, Hangzhou City (CN)

(21) Appl. No.: 17/549,892

(22) Filed: Dec. 14, 2021

Related U.S. Application Data
(63) Continuation of application No. PCT/CN2020/095249, filed on Jun. 10, 2020.

(30) Foreign Application Priority Data
Jun. 2, 2020 (CN) 202010489635.8

(51) Int. Cl. G06Q 20/38; G06Q 20/02; G06F 9/54; G06F 21/57

(52) U.S. Cl. CPC G06Q 20/389; G06Q 20/381; G06Q 20/02; G06F 2221/033; G06F 21/577; G06Q 20/383; G06F 9/547

(57) ABSTRACT

Disclosed is a coin-mixing service analysis method based on heuristic transaction analysis, including: selecting a target service to be analyzed; firstly, performing security analysis on the target service, and determining whether an API provided thereby contains vulnerability; if the API of the target service contains vulnerability, then obtaining sample transactions directly by means of the API containing the vulnerability; if the API of the target service contains no vulnerability, then obtaining sample transactions by using a small amount of Bitcoin for interaction with the service; using a heuristic transaction analysis method and determination standard to analyze the target service and the sample transaction thereof, and determine a service category to which the target service belongs; and for an obfuscated coin-mixing service, by means of a heuristic method, further using structural defects contained in transactions generated by the coin-mixing service to identify all coin-mixing transactions of the obfuscated coin-mixing service.

### TECHNICAL FIELD

The present disclosure relates to the field of digital currency and blockchain security, in particular to a coin-mixing service analysis method based on heuristic transaction analysis.

### BACKGROUND

Bitcoin is the most widely used digital currency with the largest market value in digital currency ecosystem. Compared with traditional payment methods (such as paper money and credit cards), Bitcoin has the advantage of anonymity and decentralization. It has the advantages that transactions do not need any third-party service, transactions are irrevocable and authenticity can be verified, and the pseudonymity of Bitcoin addresses makes it difficult to associate addresses with real user identities.

However, the anonymity provided by Bitcoin itself is controversial. On the one hand, all Bitcoin transfer records are publicly visible, so the cash flow between Bitcoin addresses can be completely restored; on the other hand, the anonymity mechanism of Bitcoin depends on the pseudonymity of addresses in Bitcoin transactions, and this pseudonymity can be reversely analyzed and anti-anonymized by simple heuristic methods. As long as the correspondence between user identities and address clusters can be established, the cash flow and transfer records among all Bitcoin users will be fully disclosed.

A coin-mixing service is a third-party service used to improve the anonymity of Bitcoin, which can provide stronger anonymity for users' transactions. However, in addition to the anonymity needs of ordinary users, coin-mixing services can provide strong anonymity, and thus are widely used by criminals in criminal activities. Therefore, coin-mixing services play the role of intermediary and provides money laundering services for criminal activities. Some studies have pointed out that the Silk Road, an underground market, makes extensive use of coin-mixing services for illegal transactions. On May 8, 2019, in the case of Bitcoin stolen from Binance Exchange, some of the stolen Bitcoin were sent to a famous coin-mixing service.

The extensive use of coin-mixing services in criminal activities makes it more difficult for regulators and researchers to trace the cash flow and the source of Bitcoin, so it is difficult to carry out the reconnaissance of criminal activities, and even lead to wrong reconnaissance results, because coin-mixing services intentionally obfuscate the relationship between the sender and receiver of Bitcoin. Although the research on coin-mixing services is imminent, most of the previous studies on coin-mixing services are based on case studies of several samples. The existing research lacks a deep understanding of the coin-mixing service mechanism and the coin-mixing service itself, as well as a complete analysis framework; moreover, the existing research and analysis are mostly simple case analysis, lacking of overall process analysis, and it is difficult to provide clues for forensic works such as crime investigation.

### SUMMARY

In view of the shortcomings of the prior art, the present disclosure provides a coin-mixing service analysis method based on heuristic transaction analysis, which can provide clues for the investigation of criminal activities using coin-mixing services.

The purpose of the present disclosure is achieved by the following technical solution:

A coin-mixing service analysis method based on heuristic transaction analysis, including:

S1, selecting a target service to be analyzed;

S2, firstly, performing security analysis on the target service, and determining whether an API provided thereby contains vulnerability; if the API of the target service contains vulnerability, then obtaining sample transactions directly by means of the API containing the vulnerability; if the API of the target service contains no vulnerability, then obtaining sample transactions by using a small amount of Bitcoin for interaction with the service; each of the sample transactions including a transaction input into the service and output from the service, and an original corresponding relationship between the transaction input into the service and output from the service;

S3, using a heuristic transaction analysis method and determination standard to analyze the target service and the sample transaction thereof, and determine a service category to which the target service belongs, wherein the service category includes two categories, one being an switched coin-mixing service, that is, using an output chain as a core coin-mixing process of the service, and the other one being an obfuscated coin-mixing service, that is, using single centralized output transaction and an anonymous set as a core coin-mixing process of the service; and

S4, for an obfuscated coin-mixing service, by means of a heuristic method, further using structural defects contained in transactions generated by the coin-mixing service to identify all coin-mixing transactions of the obfuscated coin-mixing service.

Further, the S3 includes:

in a case that the sample transaction having two outputs, determining that if any of the sample transactions is a transaction on an output chain, and the target service corresponding to this sample transaction is a switched coin-mixing service; and in a case that one of the sample transactions has at least three outputs, in which at least two outputs have identical values, determining that this sample transaction is for generating an anonymous set, and the target service corresponding to this sample transaction is an obfuscated coin-mixing service.

Further, the S4 includes:

(4.1) firstly, analyzing all outputs of each of the sample transactions corresponding to the target service, and if there are multiple inputs in one of the transactions using these outputs, further analyzing source transactions of these inputs; and if any of the source transactions also generates an anonymous set, determining that the source transaction also belongs to the target service; and

(4.2) repeating the step (4.1), and recording each of the source transactions of the target service obtained from each operation until no new source transaction that generates an anonymous set appears.

The present disclosure has the following beneficial effects:

According to the coin-mixing service analysis method based on heuristic transaction analysis provided by the present disclosure, firstly, the classification of coin-mixing services is realized, so that researchers can understand the coin-mixing services more deeply through the classification, and reference and assistance are provided for subsequent further research; in addition, for obfuscated coin-mixing services, by a further heuristic analysis method, all coin-mixing transactions generated by the target service can be found by using completely open blockchain data with a lower cost or no cost, which provides a basis for further in-depth research and some clues for investigation of Bitcoin criminal activities.

### BRIEF DESCRIPTION OF DRAWINGS

FIG. 1 is a flow chart of coin-mixing service analysis using the coin-mixing service analysis method of the present disclosure.

FIG. 2 is an algorithm flow chart using coin-mixing transaction identification heuristics.

### DESCRIPTION OF EMBODIMENTS

The purpose and effect of the present disclosure will become clearer by describing the present disclosure in detail according to the drawings and preferred embodiments. It should be understood that the specific embodiments described here are only used to explain the present disclosure, and are not used to limit the present disclosure.

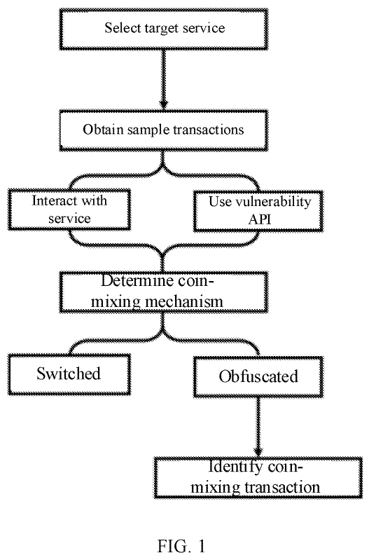

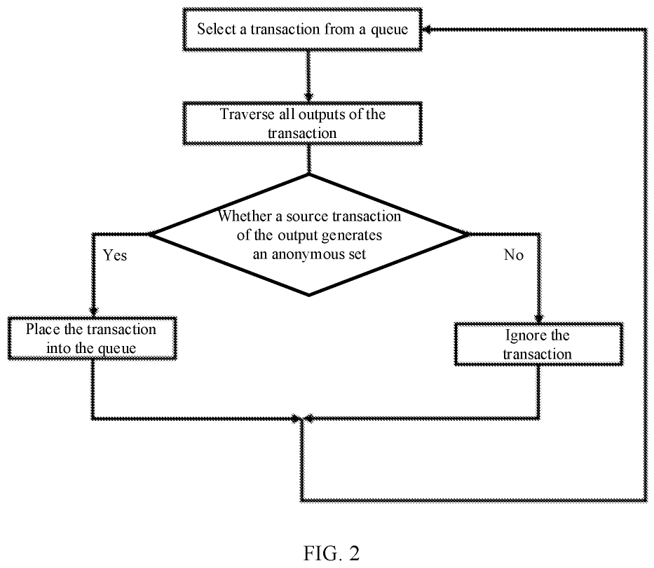

As shown in FIGS. 1-2, the coin-mixing service analysis method based on heuristic transaction analysis of the present disclosure includes the following steps:

S1, selecting a target service to be analyzed;

wherein, as one of the implementations, the current coin-mixing service market can be investigated according to the coin-mixing service information and public media reports on BitcoinTalk official forum, omitting false and closed services, and selecting feasible services; for the purpose of criminal investigation, the target service has generally been determined;

S2, firstly, performing security analysis on the target service, and determining whether an API provided thereby contains vulnerability; if the API of the target service contains vulnerability, then obtaining a sample transaction directly by means of the API containing the vulnerability; if the API of the target service contains no vulnerability, then obtaining sample transaction by using a small amount of Bitcoin for interaction with the service; the sample transaction including a transaction input into the service and output from the service, and an original corresponding relationship between the transaction input into the service and output from the service;

S3, using a heuristic transaction analysis method and determination standard to analyze the target service and the sample transaction thereof, and determine a service category to which the target service belongs, wherein the service category includes two categories, one being an switched coin-mixing service, that is, using an output chain as a core coin-mixing process of the service, and the other one being an obfuscated coin-mixing service, that is, using a centralized output transaction and an anonymous set as a core coin-mixing process of the service;

when the sample transaction has two outputs, determining that the sample transaction is a transaction on an output chain, and the target service corresponding to the sample transaction is a switched coin-mixing service; when the sample transaction contains more than three outputs and at least two outputs have identical values, determining that the sample transaction is for generating anonymous sets, and the target service corresponding to the sample transaction is a obfuscated coin-mixing service;

S4, for an obfuscated coin-mixing service, by means of a heuristic method, further using structural defects contained in transactions generated by the coin-mixing service to identify all coin-mixing transactions of the obfuscated coin-mixing service, as specifically show in FIG. 2, which further includes:

(4.1) firstly, analyzing all outputs of the sample transactions corresponding to the target service, and if there are multiple inputs in the transaction using these outputs, further analyzing the source transaction of these inputs; and if the source transaction also generates an anonymous set, determining that the source transaction also belongs to the target service; and

(4.2) repeating the step (4.1), and recording the source transaction of the target service obtained from each operation until no new source transaction that generates an anonymous set appears.

Those skilled in the art can understand that the above is only a preferred example of the present disclosure, and is not used to limit the present disclosure. Although the present disclosure has been described in detail with reference to the aforementioned examples, for those skilled in the art, they can still modify the technical solutions described in the aforementioned examples, or replace some of the technical features equally. All modifications and equivalent substitutions within the spirit and principles of the present disclosure shall be included in the scope of protection of the present disclosure.

What is claimed is:

1. A coin-mixing service analysis method based on heuristic transaction analysis, wherein the coin-mixing service analysis method comprises:
S1, selecting a target service to be analyzed;
S2, firstly, performing security analysis on the target service, and determining whether an API provided thereby contains vulnerability; if the API of the target service contains vulnerability, then obtaining sample transactions directly by means of the API containing the vulnerability; if the API of the target service contains no vulnerability, then obtaining sample transactions by using a small amount of Bitcoin for interaction with the service; each of the sample transactions comprising an input into the service and output from the service, and an original corresponding relationship between the input into the service and output from the service;
S3, using a heuristic transaction analysis method and determination standard to analyze the target service and the sample transactions thereof, and determine a service category to which the target service belongs, wherein the service category comprises two categories, one being an switched coin-mixing service, that is, using an output chain as a core coin-mixing process of the service, and the other one being an obfuscated coin-mixing service, that is, using single centralized output transaction and an anonymous set as a core coin-mixing process of the service; and
S4, for an obfuscated coin-mixing service, by means of a heuristic method, further using structural defects contained in transactions generated by the coin-mixing service to identify all coin-mixing transactions of the obfuscated coin-mixing service.

2. The coin-mixing service analysis method based on heuristic transaction analysis according to claim 1, wherein the S3 comprises:
in a case that the sample transactions having two outputs, determining that if any of the sample transactions is a transaction on an output chain, and the target service corresponding to this sample transaction is a switched coin-mixing service; and in a case that one of the sample transactions has at least three outputs, in which at least two outputs have identical values, determining that this sample transaction is for generating an anonymous set, and the target service corresponding to this sample transaction is an obfuscated coin-mixing service.

3. The coin-mixing service analysis method based on heuristic transaction analysis according to claim 1, wherein the S4 comprises:
(4.1) firstly, analyzing all outputs of each of the sample transaction corresponding to the target service, and if there are multiple inputs in one of the transaction using these outputs, further analyzing source transactions of these inputs; and if any of the source transactions also generates an anonymous set, determining that this source transaction also belongs to the target service; and
(4.2) repeating the step (4.1), and recording each of the 0ource transactions of the target service obtained from each operation until no new source transaction that generates an anonymous set appears.
